(19) United States
(12) Patent Application Publication
(10) Pub. No.: US 2002/0088372 A1
(43) Pub. Date: Jul. 11, 2002

(54) Powder for glass ionomer-based sealer for root canal

(75) Inventors: Masao Abiru, Tokyo (JP); Kimihiko Sato, Tokyo (JP); Shinichi Kato, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: GC Corporation, Tokyo (JP)

(21) Appl. No.: 09/987,272

(22) Filed: Nov. 14, 2001

(30) Foreign Application Priority Data
Nov. 21, 2000 (JP) 2000-354855
Feb. 26, 2001 (JP) 2001-050633

(51) Int. Cl. A61C 5/00

(52) U.S. Cl. 106/35; 523/115; 523/116

(57) ABSTRACT

To provide a powder for a glass ionomer-based sealer for root canal filling, which can be easily removed from a root canal when the re-filling of the root canal is needed, while possessing the sealability and biocompatibility of dental glass ionomer cement powders of the conventional art used as sealer for root canal filling, the powder of a glass ionomer-based sealer for root canal filling is constituted by compounding a fluoroaluminosilicate glass powder with a polymer that is non-reactive with a polycarboxylic acid, such as bees wax, polyisoprene, polyisoprene copolymers, polystyrene, natural gutta-percha, carnauba wax, castor wax, shellac, dammar gum, and copal gum, and/or an inorganic filler that is non-reactive with a polycarboxylic acid, such as diatomaceous earth, talc, and perlite. A compounding amount of the polymer that is non-reactive with a polycarboxylic acid, and the inorganic filler that is non-reactive with a polycarboxylic acid, is from 2 to 70% by weight.

### BACKGROUND OF THE INVENTION

1. Field of the Invention

The present invention relates to a powder for a glass ionomer-based sealer for root canal filling, which is used for a sealer for root canal filling upon reaction with an aqueous solution of polycarboxylic acid to seal a space between a root canal wall and a gutta-percha point filled within a root canal in the root canal treatment in the dentistry.

2. Description of the Conventional Art

In the dental remedy, when the treatment for pulp disease or apical periodontitis is carried out, a materially stable substance is filled within a root canal after extirpation of a pulp to seal a space within the root canal and intercept an infectious route between the root canal and a periodontal tissue, or between the root canal and an oral cavity, thereby undergoing the root canal remedy. In carrying out this treatment, a method that is most often employed at present is a method in which a thin needle-like root canal filling material containing a gutta-percha and zinc oxide as major components, that is called a gutta-percha point, is filled within a root canal after extirpation of a pulp, followed by sealing with a cement or the like. This filling method of the root canal using a gutta-percha point is generally effected by a method in which a plurality of gutta-percha points are successively filled within the root canal, that is called a lateral condensation method. At this time, though it is necessary to fill precisely the gutta-percha points within the root canal, the gutta-percha points do not have thorough adhesion to a root canal wall enough. Accordingly, there is employed a method in which a material that is called a sealer for root canal filling is applied to the gutta-percha points and then filled within the root canal to invest a space between the root canal wall and the gutta-percha point, thereby enhancing sealability.

The sealer for root canal filling, which is broadly used at present, is a material containing zinc oxide and eugenol as major components. However, though the zinc oxide/eugenol-based sealer composition for root canal filling can invest the space between the root canal wall and the gutta-percha point, it does not have adhesive properties to both of the root canal wall and the gutta-percha point. Accordingly, there was involved such a defect that its sealability to the root canal is not sufficient from the clinical viewpoint. Further, the eugenol has a detrimental action to living bodies, and therefore, it involved a problem of safety.

On the other hand, there are commercially available products utilizing a dental glass ionomer cement used for the filling remedy or cementing in the dentistry, as the sealer composition for root canal filling. This dental glass ionomer cement used as the sealer for root canal filling has an adhesive ability to a tooth and can adhere to the gutta-percha point, too. Accordingly, the dental glass ionomer cement is superior in the sealability to a root canal and is superior in the safety because of its high biocompatibility. However, in general, the dental glass ionomer cement is not substantially used for the reasons as described later.

In general, the root canal is in a complicated shape, and from three to four root canals may be present per tooth depending on the kind of the tooth. Further, the shape includes various variations such as a flat shape, a barrel shape, and a curved shape, depending on the individual teeth. For these reasons, even when the treatment is carried out using the gutta-percha point and the sealer for root canal filling as described above, it is difficult to completely seal the root canal to every detail, thereby preventing invasion of bacteria, resulting in possible occurrence of a toothache or a swelling of ginginva by the invasion of bacteria or the like. In such case, it is necessary to carry out again the root canal treatment. In other words, it is necessary to remove the gutta-percha point and the sealer, each of which is filled within the root canal, by a reamer or a file and to fill again a gutta-percha point by means of the above-described lateral condensation method or other methods.

However, in the case where the glass ionomer cement used as the sealer is used, not only its adhesive properties to the gutta-percha point and a dentin are high, but also its strength is high (the compression strength is approximately 110 MPa; and the compression strength of the zinc oxide/eugenol-based sealer composition is about 10 to 30 MPa). Accordingly, it is very difficult to remove the gutta-percha point and the glass ionomer cement while cutting, by means of a reamer or a file. Thus, there was often a case where the tooth extraction is inevitably carried out while giving up the removal of the gutta-percha point.

### SUMMARY OF THE INVENTION

Thus, the present invention is aimed to overcome the defects of the conventional art as described above and to provide a powder for a glass ionomer-based sealer to be used as a sealer for root canal filling, which can be easily removed from a root canal when there-filling of the root canal is needed, while possessing superior sealability and biocompatibility of the glass ionomer cement powders of the conventional art.

In order to achieve the above-described aim, we, the present inventors, made extensive and intensive investigations. As a result, it has been found that if the strength of a glass ionomer cement after curing is lowered to such extent that the glass ionomer cement can be cut and removed by a reamer or a file, a powder for a glass ionomer-based sealer for root canal filling to be used for a sealer for root canal filling, which can be easily cut and removed by a reamer or a file, when the re-filling of a root canal is carried out, while keeping superior sealability and biocompatibility of the glass ionomer cement, can be provided, leading to accomplishment of the invention.

Specifically, the powder for a glass ionomer-based sealer for root canal filling according to the present invention comprises a fluoroaluminosilicate glass powder having a polymer that is non-reactive with a polycarboxylic acid, and/or an inorganic filler that is non-reactive with a polycarboxylic acid, compounded therein. The powder for a glass ionomer-based sealer for root canal filling according to the present invention is polymerized upon reaction with a polycarboxylic acid in the presence of water and then provided for use, likewise the dental glass ionomer cement powders of the conventional art used as a sealer for root canal filling. At this time, it is preferred that the fluoroaluminosilicate glass powder is compounded with 2 to 70% by weight of the polymer that is non-reactive with a polycarboxylic acid, and/or the inorganic filler that is non-reactive with a polycarboxylic acid. Also, it is preferred that the polymer that is non-reactive with a polycarboxylic acid is at least one polymer selected from bees wax, polyisoprene, polyisoprene copolymers, polystyrene, natural gutta-percha, carnauba wax, castor wax, shellac, dammar gum, and copal gum; and that the inorganic filler that is non-reactive with a polycarboxylic acid is at least one member selected from diatomaceous earth, talc, and perlite.

### DESCRIPTION OF THE PREFERRED EMBODIMENTS

As the fluoroaluminosilicate glass powder that is used for the powder for a glass ionomer-based sealer for root canal filling according to the present invention, employable are fluoroaluminosilicate glass powders that are generally used for a dental glass ionomer cement. Of these, preferred is a powder containing, as main components, 10 to 25% by weight of Al³⁺, 5 to 30% by weight of Si⁴⁺, 1 to 30% by weight of F⁻, 0 to 20% by weight of Sr²⁺, 0 to 20% by weight of Ca²⁺, and 0 to 10% by weight of an alkali metal ion (e.g., Na⁺, K⁺), based on the total weight of the glass, which is prepared by mixing and melting raw materials containing these components, cooling the molten mixture, and then grinding the mixture so as to have a mean particle size of about 0.02 to 20 μm.

As the polymer that is non-reactive with a polycarboxylic acid, which is used for the powder for a glass ionomer-based sealer for root canal filling according to the present invention, can be enumerated natural polymers such as celluloses, and synthetic polymers. More specifically, suitable are water-insoluble celluloses such as cellulose acetate, celluloid, carboxymethyl cellulose, ethyl cellulose, cellulose propionate, and cellulose nitrate. Examples of other natural polymers that can be used include bees wax, starch, natural gutta-percha, keratin, carnauba wax, castor wax, shellac, gum arabic, ester gum, dammar gum, casein, copal gum, Japan wax, rosin, and natural rubber.

Examples of the synthetic polymers include rubber-based polymers such as polyisoprene, polybutadiene, polybutyl rubber, polychloroprene, acrylic rubber, epichlorohydrin rubber, urethane rubber, polysulfide rubber, silicone rubber, and fluorocarbon rubber and copolymers thereof; olefinic polymers (such as polyethylene, polypropylene, and polybutylene) and copolymers thereof; acrylic polymers (such as poly(meth)acrylates) and copolymers thereof; styrene-based polymers (such as polystyrene, acrylonitrile-styrene copolymers, butadiene-styrene copolymers, and ABS (acrylonitrile-butadiene-styrene) polymers) and copolymers thereof; vinyl-based polymers (such as polyvinylidene chloride, chlorinated polyvinyl chloride, and propylene-vinyl chloride copolymer) and copolymers thereof; amide-based polymers (such as nylon 6, nylon 66, nylon 610, nylon 612, nylon 11, nylon 12, and nylon 46); unsaturated polyester resins (such as polyethylene terephthalate); fluorocarbon-based polymers (such as polytetrafluoroethylene, polytrifluoroethylene, and polyvinylidene fluoride) and copolymers thereof; and other polymers (such as polycarbonate, polyacetal, polyether sulfone, polyphenylene oxide, polyphenylene sulfide, and polysulfone) and copolymers thereof. These polymers that are non-reactive with a polycarboxylic acid may be used singly or in admixture of two or more thereof. Further, copolymers of each of these polymers may be used.

The inorganic filler that is non-reactive with a polycarboxylic acid is not particularly limited, so far as it does not have a detrimental action to living bodies. However, suitable are inorganic fillers that are usually used as a dental material, such as quartz, cristobalite, diatomaceous earth, fused quartz, titanium dioxide, fumed silica, talc, and perlite. Of these, suitable are diatomaceous earth, talc, and perlite, each of which is relatively soft.

It is preferred that the polymer that is non-reactive with a polycarboxylic acid, and/or the inorganic filler that is non-reactive with a polycarboxylic acid, is compounded in an amount ranging from 2 to 70% by weight in the fluoroaluminosilicate glass powder depending on the kind thereof, such that the sealer composition for root canal filling after curing has a compression strength of 10 to 70 MPa. When the compression strength is lower than 10 MPa, the adhesive properties to the dentin or the gutta-percha point tend to be deteriorated. On the other hand, when the compression strength exceeds 70 MPa, it is difficult to carry out cutting and removal by a reamer or a file. And, when the compounding amount is less than 2% by weight, the effect for lowering the strength of the sealer for root canal filling after curing is liable to be hardly obtained. On the other hand, when the compounding amount exceeds 70% by weight, the adhesive properties to the dentin or the gutta-percha point are deteriorated so that the sealability tends to become worse. Incidentally, since a dental prosthesis having a high strength is built up on the tooth after root canal filling, the sealer composition for root canal filling is not required to have a high strength. Actually, the zinc oxide/eugenol-based sealer compositions for root canal filling, which are broadly used at present, have a strength of about 10 to 30 MPa in terms of compression strength. Accordingly, the sealer for root canal filling using the powder for a glass ionomer-based sealer for root canal filling according to the present invention has a sufficiently high strength so that the sealer for root canal filling can exhibit the desired function.

The polymer that is non-reactive with a polycarboxylic acid may be in any form of a powdered state or a liquid state, so far as it is stable within the root canal. However, in the case where it is in a powdered state, it is preferred that the polymer is a polymer powder having a mean particle size of 0.1 to 30 μm, which is generally used as a dental filling material. Further, the shape of the inorganic filler that is non-reactive with a polycarboxylic acid is not particularly limited, so far as the above-described strength is obtained. However, it is preferred to use inorganic fillers having a mean particle size of 0.02 to 30 μm, which are generally used as a dental filling material.

With respect to the polymer that is hardly processed in a powdered state and hence, is hardly compounded into the fluoroaluminosilicate glass powder, such as rubber-based polymers, it is possible to compound a powder prepared by filling and mixing the fluoroaluminosilicate glass powder or the inorganic filler that is non-reactive with a polycarboxylic acid, in the rubbery polymer, followed by grinding and then provide the mixture for use.

The sealer for root canal filling using the powder for a glass ionomer-based sealer for root canal filling according to the present invention has a strength comparable to or much higher than that of the zinc oxide/eugenol-based sealer compositions for root canal filling of the conventional art. Accordingly, in the case where the root canal treatment is again required, the sealer for root canal filling can be easily removed from the interior of the root canal by means of a reamer or a file. Further, in the case where the sealer for root canal filling is removed while using a specific polymer as the polymer that is non-reactive with a polycarboxylic acid, if a solvent capable of dissolving the polymer therein is used and dissolves the polymer, the sealer for root canal filling can be easily removed from the interior of the root canal in a state that the strength of the sealer for root canal filler is further lowered, and hence, such is preferred. For example, bees wax is soluble in chloroform; and polyisoprene, polyisoprene copolymers, polystyrene, and natural gutta-percha are soluble in chloroform, eucalyptus oil, limonene, xylene, and the like. Further, carnauba wax and castor wax are soluble in chloroform, ethanol, ether, limonene, and eucalyptus oil; shellac are soluble in alcohols and esters; dammar gum is soluble in chloroform, benzene, and ether; and copal gum is soluble in alcohols. Accordingly, these polymers and solvents can be used.

The powder for a glass ionomer-based sealer for root canal filling according to the present invention is reacted with a polycarboxylic acid in the presence of water to polymerize and then provided for use, likewise the dental glass ionomer cement powders of the conventional art used as the sealer for root canal filling. As the polycarboxylic acid that is used at this time, employable are polymers of α,β-unsaturated monocarboxylic acids or α,β-unsaturated dicarboxylic acids, which are a polycarboxylic acid used for the general dental glass ionomer cement. Specific examples include copolymers or homopolymers of, e.g., acrylic acid, methacrylic acid, 2-chloroacrylic acid, 3-chloroacrylic acid, aconitic acid, mesaconic acid, maleic acid, itaconic acid, fumaric acid, glutaconic acid, citraconic acid, etc., having a weight average molecular weight of 5,000 to 40,000.

The powder for a glass ionomer-based sealer for root canal filling according to the present invention, which comprises a fluoroaluminosilicate glass powder having a polymer that is non-reactive with a polycarboxylic acid, and/or an inorganic filler that is non-reactive with a polycarboxylic acid, compounded therein, is mixed with an aqueous solution of a polycarboxylic acid in a weight ratio ranging from 3/1 to 1/3 and then provided for use, like the usual sealer compositions for root canal filling.

As a matter of course, to the powder for a glass ionomer-based sealer for root canal filling according to the present invention, may be added bactericides, X-ray contrast media, coloring agents, plasticizers, etc. that are compounded in the dental glass ionomer cement powders of the conventional art, so far as the characteristics are not hindered. In particular, the coloration with a coloring agent is preferred because it is easy to discriminate the sealer for root canal filling from a tooth during removal from the interior of the root canal, thereby making the cutting and removal of the sealer for root canal filling easy.

The invention will be described in detail with reference to the following Examples, but it should not be construed that the invention is limited thereto.

### EXAMPLE 1

A powder of a commercially available dental glass ionomer cement (a trade name: Fuji Ionomer Type III, made by GC Corporation) was compounded with 18% by weight of a talc powder to prepare a powder for a glass ionomer-based sealer for root canal filling. 1.2 g of this powder was mixed with 1 g of a solution (an aqueous solution of polycarboxylic acid) of the same product (a trade name: Fuji Ionomer Type III, made by GC Corporation) and mixed with each other for 30 seconds to prepare a sealer composition for root canal filling. This sealer composition for root canal filling was tested for compression strength, sealability, and easiness of removal from root canal in the following test methods. The results obtained are summarized and shown in Table 1.

(a) Compression Strength:

The powder for a glass ionomer-based sealer for root canal filling was mixed with the polycarboxylic acid solution according to the Examples, and the mixture was tested for compression strength pursuant to the method as defined in JIS T6607, “Dental glass polyalkenote cement”.

(b) Sealability:

A standard human maxillary lateral incisor, which, after extraction of tooth, had been stored in a 10% formalin solution, was used as a sample. After cutting of the tip of the sample and opening of pulp chamber, followed by subjecting the human maxillary lateral incisor to a usual root canal enlargement operation to form a root canal. In the root canal, filled was a gutta-percha point (a trade name: GC Gutta-percha Point, made by GC Corporation) coated with the sealer composition for root canal filling as prepared by mixing the powder for a glass ionomer-based sealer for root canal filling according to the present invention and the aqueous solution of polycarboxylic acid with each other, in the lateral condensation method. This sample was immersed in an aqueous solution of 0.6% rhodamine in a incubator at 37° C. for 7 days. Thereafter, the tooth was cut, and the length between the root canal wall and the sealer composition for root canal filling, and the length between the gutta-percha point and the sealer composition for root canal filling, each colored by the aqueous solution of rhodamine, were measured, respectively.

(c) Easiness of Removal from Root Canal:

With respect to a standard human maxillary lateral incisor, which had been subjected to root canal filling in the same manner as in (b) above, the gutta-percha point and the sealer composition for root canal filling were removed by a root canal enlargement operation using a reamer and a file, whereby the easiness of removal was confirmed. Further, with respect to Examples 6 to 9, the gutta-percha point and the sealer composition for root canal filling were removed using a reamer and a file, while applying a solvent, whereby the easiness of removal from the root canal wall was confirmed. The evaluation was carried out according to the following criteria.

A: The cutting resistance is lower than that of a dentin, and the sealer composition for root canal filling can be easily cut and removed by the reamer and the file.

B: The cutting resistance is comparable to that of a dentin, and the sealer composition for root canal filling can be relatively easily cut and removed by the reamer and the file.

C: The cutting resistance is so high that it is difficult to cut the sealer composition for root canal filling by the reamer and the file. But, if a time is spent, the sealer composition for root canal filling can be removed.

D: Since the sealer composition for root canal filling cannot be substantially cut by the reamer and the file, it cannot be removed.

### EXAMPLE 2

A powder of a commercially available dental glass ionomer cement (a trade name: Fuji IXGP, made by GC Corporation) was compounded with 53% by weight of a polymethyl methacrylate powder having a mean particle size of 19 μm to prepare a powder for a glass ionomer-based sealer for root canal filling. 1.2 g of this powder was mixed with 1 g of a solution (an aqueous solution of polycarboxylic acid) of the same product (a trade name: Fuji IXGP, made by GC Corporation) and mixed with each other for 30 seconds to prepare a sealer composition for root canal filling. This sealer composition for root canal filling was subjected to various tests in the same manner as in Example 1. The results obtained are summarized and shown in Table 1.

### EXAMPLE 3

A powder of a commercially available dental glass ionomer cement (a trade name: Fuji Ionomer Type II, made by GC Corporation) was compounded with 8% by weight of diatomaceous earth to prepare a powder for a glass ionomer-based sealer for root canal filling. 1.3 g of this powder was mixed with 1 g of a solution (an aqueous solution of polycarboxylic acid) of the same product (a trade name: Fuji Ionomer Type II, made by GC Corporation) and mixed with each other for 30 seconds to prepare a sealer composition for root canal filling. This sealer composition for root canal filling was subjected to various tests in the same manner as in Example 1. The results obtained are summarized and shown in Table 1.

### EXAMPLE 4

A powder of a commercially available dental glass ionomer cement (a trade name: Fuji Ionomer Type II, made by GC Corporation) was compounded with 8% by weight of a polystyrene powder having a mean particle size of 20 μm to prepare a powder for a glass ionomer-based sealer for root canal filling. 1.3 g of this powder was mixed with 1 g of a solution (an aqueous solution of polycarboxylic acid) of the same product (a trade name: Fuji Ionomer Type II, made by GC Corporation) and mixed with each other for 30 seconds to prepare a sealer composition for root canal filling. This sealer composition for root canal filling was subjected to various tests in the same manner as in Example 1. The results obtained are summarized and shown in Table 1.

### EXAMPLE 5

A powder of a commercially available dental glass ionomer cement (a trade name: Fuji Ionomer Type II, made by GC Corporation) was compounded with 20% by weight of a castor wax powder having a mean particle size of 15 μm to prepare a powder for a glass ionomer-based sealer for root canal filling. 1.3 g of this powder was mixed with 1 g of a solution (an aqueous solution of polycarboxylic acid) of the same product (a trade name: Fuji Ionomer Type II, made by GC Corporation) and mixed with each other for 30 seconds to prepare a sealer composition for root canal filling. This sealer composition for root canal filling was subjected to various tests in the same manner as in Example 1. The results obtained are summarized and shown in Table 1.

### EXAMPLE 6

A powder of a commercially available dental glass ionomer cement (a trade name: Fuji Ionomer Type II, made by GC Corporation) was compounded with 47% by weight of a polyisoprene-polystyrene copolymer and 0.08% by weight of red oxide as a dyestuff, to prepare a glass ionomer cement powder for a sealer for root canal filling. 1.4 g of this powder was mixed with 1 g of a solution (an aqueous solution of polycarboxylic acid) of the same product (a trade name: Fuji Ionomer Type II, made by GC Corporation) and mixed with each other for 30 seconds to prepare a sealer composition for root canal filling. With respect to the test of “(c) Easiness of removal from root canal”, chloroform was used as the solvent. This sealer composition for root canal filling was subjected to various tests in the same manner as in Example 1. The results obtained are summarized and shown in Table 1. Further, since the sealer for root canal filling was colored red, it was easy to discriminate the sealer for root canal filling from the tooth during the removal from the root canal.

### EXAMPLE 7

A powder of a commercially available dental glass ionomer cement (a trade name: Fuji Ionomer Type III, made by GC Corporation) was compounded with 25% by weight of a powder of polyisoprene (a trade name: Kuraray Gutter TP-301, made by Kuraray Co., Ltd.) having amean particle size of 25 μm and 0.08% by weight of red oxide as a dyestuff, to prepare a powder for a glass ionomer-based sealer for root canal filling. 1.3 g of this powder was mixed with 1 g of a solution (an aqueous solution of polycarboxylic acid) of the same product (a trade name: Fuji Ionomer Type III, made by GC Corporation) and mixed with each other for 30 seconds to prepare a sealer composition for root canal filling. With respect to the test of “(c) Easiness of removal from root canal”, eucalyptus oil was used as the solvent. This sealer composition for root canal filling was subjected to various tests in the same manner as in Example 1. The results obtained are summarized and shown in Table 1.

### EXAMPLE 8

A powder of a commercially available dental glass ionomer cement (a trade name: Fuji Ionomer Type II, made by GC Corporation) was compounded with 10% by weight of natural gutta-percha and 0.08% by weight of red oxide as a dyestuff, to prepare a powder for a glass ionomer-based sealer for root canal filling. 1.4 g of this powder was mixed with 1 g of a solution (an aqueous solution of polycarboxylic acid) of the same product (a trade name: Fuji Ionomer Type II, made by GC Corporation) and mixed with each other for 30 seconds to prepare a sealer composition for root canal filling. With respect to the test of “(c) Easiness of removal from root canal”, chloroform was used as the solvent. This sealer composition for root canal filling was subjected to various tests in the same manner as in Example 1. The results obtained are summarized and shown in Table 1. Further, since the sealer for root canal filling was colored red, it was easy to discriminate the sealer for root canal filling from the tooth during the removal from the root canal.

### EXAMPLE 9

Polyisoprene (a trade name: Kuraray Gutter TP-301, made by Kuraray Co., Ltd.), which had been softened by heating at 70° C., was compounded and mixed with 78% by weight of a powder of a commercially available dental glass ionomer cement (a trade name: Fuji Ionomer Type III, made by GC Corporation). The mixture was then freeze-dried and ground to prepare a powder having a mean particle size of 25 μm. This powder was compounded in an amount of 52% by weight in a fluoroaluminosilicate glass powder (a trade name: Fuji Ionomer Type III, made by GC Corporation) to prepare powder for a glass ionomer-based sealer for root canal filling (the ultimate compounding amount of polyisoprene: 40.6% by weight). 1.2 g of this powder was mixed with 1 g of a solution (an aqueous solution of polycarboxylic acid) of the same product (a trade name: Fuji Ionomer Type III, made by GC Corporation) and mixed with each other for 30 seconds to prepare a sealer composition for root canal filling. With respect to the test of “(c) Easiness of removal from root canal”, chloroform was used as the solvent. This sealer composition for root canal filling was subjected to various tests in the same manner as in Example 1. The results obtained are summarized and shown in Table 1.

### COMPARATIVE EXAMPLE 1

A commercially available a zinc oxide/eugenol-based sealer composition for root canal filling (a trade name: Canals, made by Showa Yakuhin Kako Co., Ltd.) was used. With respect to the sealer composition for root canal filling as prepared by mixing a powder and a liquid based on the instructions of the manual, the respective tests were carried out in the same manner as in Example 1. The results obtained are summarized and shown in Table 1.

### COMPARATIVE EXAMPLE 2

A commercially available glass ionomer cement for root canal filling (a trade name: Ketac-Endo, made by ESPE) was used. With respect to the sealer composition for root canal filling as prepared by mixing a powder and a liquid based on the instructions of the manual, the respective tests were carried out in the same manner as in Example 1. The results obtained are summarized and shown in Table 1.

TABLE 1

| | | Sealability | | |
|---|---|---|---|---|
| | | Invasion length of | | |
| | | aqueous solution of | | |
| | | Rhodamine (mm) | | |
| | | Between | | Easiness |
| | | root | | of |
| | | canal | Between | removal |
| | Compression | wall | gutta-percha | from |
| | strength | and | point and | root |
| | (MPa) | sealer | sealer | canal |
| Example 1 | 45 | 1.2 | 0.8 | B |
| Example 2 | 51 | 1.0 | 0.6 | C |
| Example 3 | 27 | 1.3 | 1.0 | B |
| Example 4 | 50 | 1.3 | 0.9 | B |
| Example 5 | 22 | 1.5 | 1.3 | B |
| Example 6 | 24 | 1.7 | 1.5 | A |
| Example 7 | 28 | 1.3 | 1.0 | A |
| Example 8 | 42 | 1.4 | 1.1 | A |
| Example 9 | 32 | 1.6 | 1.3 | A |
| Comparative | 28 | 2.4 | 2.5 | A |
| Example 1 | | | | |
| Comparative | 112 | 1.3 | 1.1 | D |
| Example 2 | | | | |

It has been confirmed from Examples 1 to 9 that while the powder for a glass ionomer-based sealer for root canal filling according to the present invention possesses a sealability comparable to that of the glass ionomer cements of the conventional art used, it can be easily cut out and surely removed even as to the details thereof by a reamer or a file. In particular, in Examples 6 to 9, since the polymer component contained in the powder for a glass ionomer-based sealer for root canal filling, that is non-reactive with the polycarboxylic acid, such as polyisoprene, polyisoprene copolymers and natural gutta-percha, is dissolved in the solvent such as chloroform, it is possible to easily remove the sealer from the root canal by lowering the strength during cutting, even when the compression strength is high to some extent. Further, with respect to the sealability, it has been confirmed that the powder for a glass ionomer-based sealer for root canal filling according to the present invention is comparable to the conventional art glass ionomer cements for root canal filling.

As described above in detail, the sealer for root canal filling using the powder for a glass ionomer-based sealer for root canal filling according to the present invention has adhesive properties to both the gutta-percha point and the root canal wall. Accordingly, while it is superior in the sealability to the root canal and has a biocompatibility as high as in that of the glass ionomer cement, it can be easily removed from the root canal when the re-remedy of the root canal is needed. Thus, the invention is greatly valuable in contribution to the dental remedy.

While the invention has been described in detail and with reference to specific embodiments thereof, it will be apparent to one skilled in the art that various changes and modifications can be made therein without departing from the spirit and scope thereof.

What is claimed is:

1. A powder for a glass ionomer-based sealer for root canal filling, comprising a fluoroaluminosilicate glass powder having a polymer that is non-reactive with a polycarboxylic acid, and/or an inorganic filler that is non-reactive with a polycarboxylic acid, compounded therein.

2. The powder for a glass ionomer-based sealer for root canal filling as claimed in claim 1, wherein the fluoroaluminosilicate glass powder is compounded with 2 to 70% by weight of the polymer that is non-reactive with a polycarboxylic acid and/or the inorganic filler that is non-reactive with a polycarboxylic acid.

3. The powder for a glass ionomer-based sealer for root canal filling as claimed in claim 1 or 2, wherein the polymer that is non-reactive with a polycarboxylic acid is at least one polymer selected from bees wax, polyisoprene, polyisoprene copolymers, polystyrene, natural gutta-percha, carnauba wax, castor wax, shellac, dammar gum, and copal gum.

4. The powder for a glass ionomer-based sealer for root canal filling as claimed in any one of claims 1 to 3, wherein the inorganic filler that is non-reactive with a polycarboxylic acid is at least one member selected from diatomaceous earth, talc, and perlite.
